(19) United States
(12) Patent Application Publication
(10) Pub. No.: US 2014/0064840 A1
(43) Pub. Date: Mar. 6, 2014

(54) Apparatus for Suspending Filter in Manhole and Method for On-Route Decanting of Storm Water

(71) Applicant: Stephen McInnis, Portland, OR (US)

(72) Inventor: Stephen McInnis, Portland, OR (US)

(21) Appl. No.: 13/969,517

(22) Filed: Aug. 17, 2013

Related U.S. Application Data
(60) Provisional application No. 61/696,355, filed on Sep. 4, 2012.

(51) Int. Cl. F16B 2/04

(52) U.S. Cl. CPC F16B 2/04
USPC 403/374.3

(57) ABSTRACT

An expansion ring has multiple adjustable expansion joints and plural bolts around the periphery of the ring that have pointed tips that bear into the sides of an existing manhole. The combination of the expansion joints and bolts allows the expansion ring to be securely affixed in the manhole. A filter basket assembly is suspended from the expansion ring into the manhole. Plural expansion rings with filter basket assemblies are strategically located along a clean-out route so that a full Vactor truck or sweeper may be emptied—decanted—into the filter basket assemblies on-route rather than at a traditional treatment plants.

### FIELD OF THE INVENTION

This invention relates to an apparatus that allows a filter to be suspended in an existing manhole so that fluids may be decanted and filtered as they are emptied into a storm sewer system, and to a method of decanting fluids on-route.

### BACKGROUND

So-called Vactor trucks and sweepers are used to maintain storm drains as part of a daily routine for municipalities and stormwater maintenance contractors. The equipment is essential for keeping trash and debris out of the stormwater system and is a primary line of defense for environmental protection. Stated simply, a Vactor truck uses vacuum force to suck debris from storm drains to remove debris. As the debris is sucked into the truck, a substantial amount of water is also sucked into the truck. The trucks tend to fill rapidly, most of the load is water and a smaller percentage is the debris that was removed from the storm drains.

When the trucks are full they are typically driven to a treatment plant where the contents—the liquid and debris—are decanted into the treatment plant for processing. Vactor trucks typically follow a set route and the distance driven to the treatment plant is often significant—the treatment plants are rarely close to the route that the driver is following.

Operating a Vactor truck is very costly. There is the upfront capital for the equipment, fuel to keep the equipment going, employee wages and the cost of disposal at the treatment facility. The high mileage driven by the trucks also takes a toll, not to mention the wear and tear on the vehicle, employee time traveling to the treatment plant and back to the scheduled route.

There is a need therefore for equipment and methods that simplify and make more efficient the process of storm drain cleanout.

### SUMMARY

The present invention comprises an expansion ring that is designed to be installed in existing manholes so that a filter may be suspended in the manhole. The expansion rings and filters are installed in manholes at strategic locations on storm drain cleanout routes so that the full Vactor trucks can be decanted on-route instead of driving to a treatment facility.

The expansion ring is adaptable to most pre-existing and new manholes. The ring has multiple adjustable expansion joints and plural bolts around the periphery of the ring that have pointed tips that bear into the sides of the manhole. The combination of the expansion joints and bolts allows the expansion ring to be securely affixed in the manhole. A filter basket assembly is suspended from the expansion ring into the manhole.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a side elevation and cross sectional view of the present invention, illustrating the expansion ring installed in a typical manhole with a filter of the type described in U.S. Pat. No. 8,221,632 suspended below the expansion ring.

FIG. 2 is an upper perspective view of the expansion ring according to the present invention showing the expansion ring in isolation.

FIG. 3 is a plan view of one of the plural retaining bolts used with the expansion ring, the bolt having a sharpened tip for bearing on the interior surface of the manhole.

FIG. 4 is a perspective view of one of the plural expansion joints used with the expansion ring according to the present invention.

FIG. 5 is a side elevation view illustrating an expansion joint and two retaining bolts.

FIG. 6 is an upper perspective view of an alternative embodiment of the expansion ring according to the present invention, the illustrated expansion ring having a single expansion joint and a hinge in the ring opposite the expansion joint.

### DETAILED DESCRIPTION

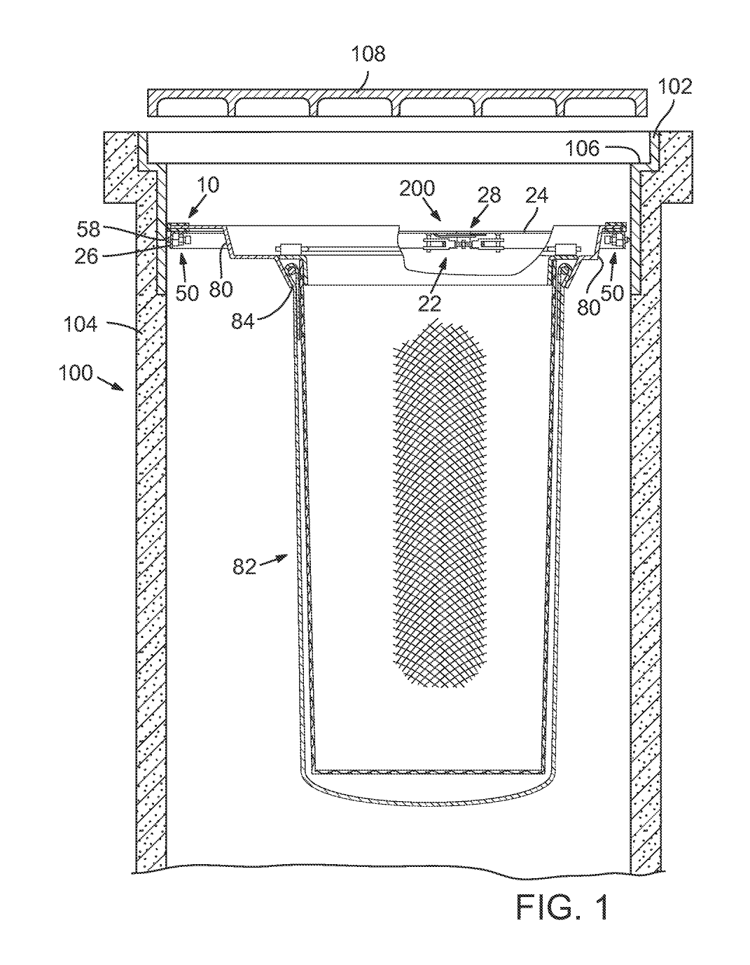

With reference to the figures, an apparatus 10 according to the present invention is seen as comprising an expansion ring 12 that is designed to be installed in an existing manhole 100. The manhole 100 is part of a storm drain system in a municipal sewer system and typically is located in a roadway. The manhole is of a conventional construction and is typically cylindrical and made of precast concrete. The manhole shown in FIG. 1 has a metal ring 102 formed into the concrete sidewall 104 and the metal ring defines a lip 106 that supports a conventional grate 108. It is to be understood that the present invention is designed to be installed in many different types of existing manholes including those without metal rings 102.

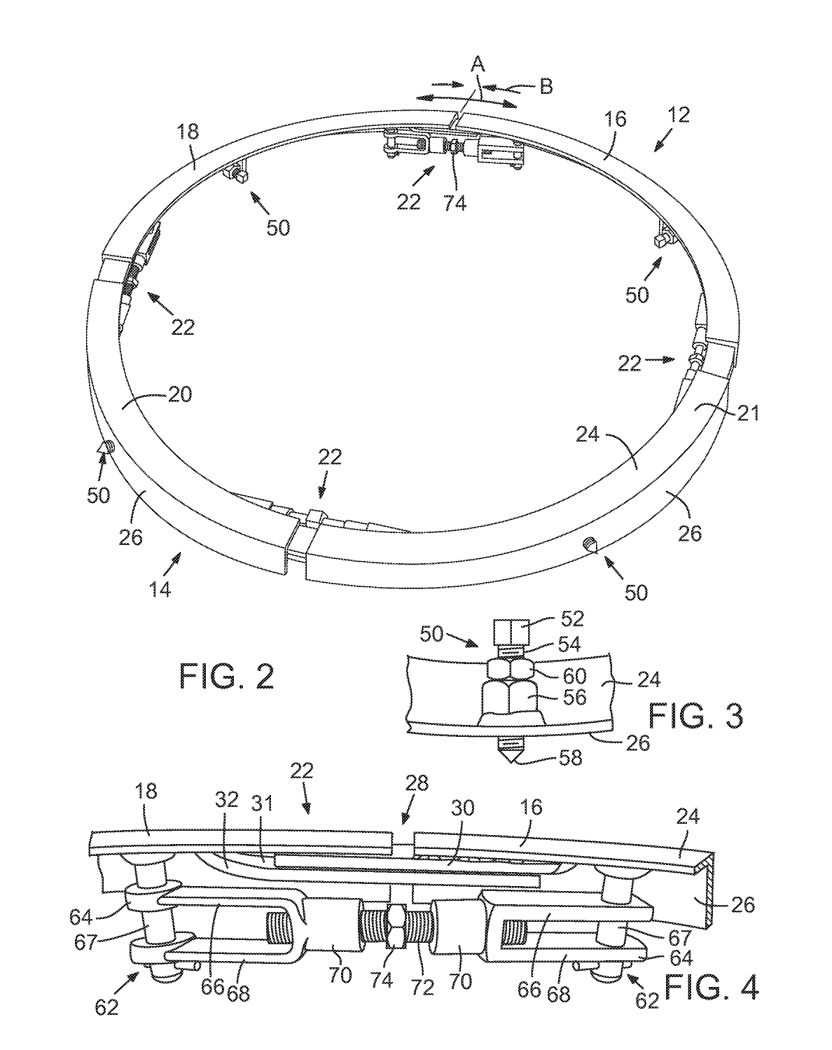

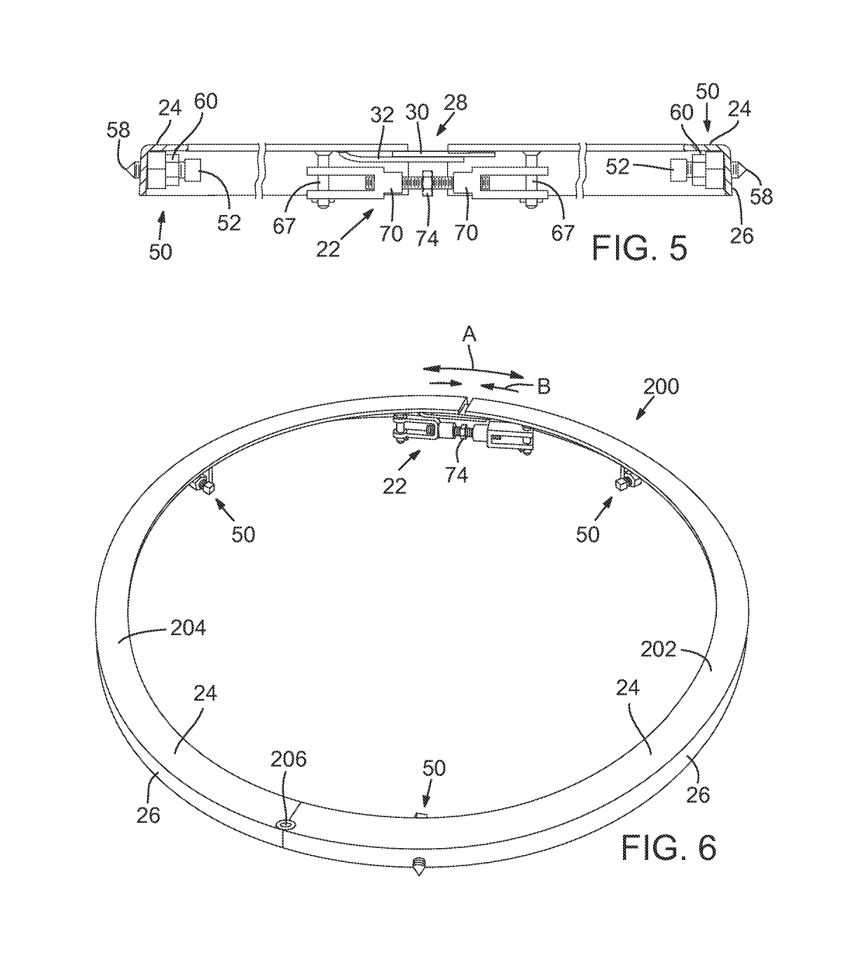

Turning now to FIGS. 2, 3 and 4, the expansion ring 12 is shown in isolation. The embodiment shown defines a circular ring member 14 that includes four curved or arcuate sections 16, 18, 20 and 21, each attached to the adjacent section by an expansion joint 22 so that the combination of the four interconnected sections defines a circular member that, as detailed below, has a diameter that may be varied. The embodiment further illustrates four retaining bolts 50, one in each of the sections 16, 18, 20 and 21.

The sections 16, 18 and 20 are curved L-shaped metallic sections that have a flattened, peripherally extending upper shelf portion 24 and a generally vertical side wall portion 26 through which the retaining bolts 50 extend and which defines the peripheral edge of the ring 12.

Adjacent sections 16, 18, 20 and 21 are attached to each other by the expansion joints 22 (described below) and a slip joint 28 defined by opposing metallic arms 30 and 32 welded onto the adjacent sections and which together define an intermeshing arrangement where the arm 30 of one section slips into a channel 31 defined by the arm 32 of the adjacent section to thereby allow the adjacent sections to move relative to one another yet remain stably connected. The slip joints thus define a stabilizing feature that allows the adjacent sections to be manipulated with the expansion joints while the sections are stable relative to one another. With reference to FIG. 4, arm 30 is welded to the interior portion of section 16, to the lower surface opposite shelf 24, and extends outwardly past the edge of the section toward adjacent section 18. Arm 32 is welded to the interior portion of section 18, to the lower surface opposite shelf 24 and extends outwardly past the edge of the section toward adjacent section 16. Arm 32 is spaced apart from the material that defines shelf 24 to define the channel 31. When sections 16 and 18 are assembled, arm 30 is inserted into channel 31 as indicated in the drawings to stabilize the two sections relative to one another, for example, during installation of the expansion ring 12 into a manhole 100 as detailed below.

Each retaining bolt 50 is defined by a nut having a standard hex end 52 in the interior of the expansion ring 12, a threaded shaft 54 that is threaded through a nut 56 welded to the interior of vertical side wall portion 26. The retaining bolt 50 extends through the vertical side wall portion 26 with the distal end 58 of the retaining bolt 50 exposed to the exterior of the ring. The distal end 58 is pointed so that it may bear into the interior wall of the manhole 100 during installation. A lock nut 60 is threaded onto threaded shaft 54 between hex end 52 and nut 56 to act as a lock.

Each expansion joint 22 is defined by a generally U-shaped turnbuckle 62 having one end 64 pivotally connected to a shaft 67 that is welded to the underside of the interior of shelf 24—the opposite ends of arms 66 and 68 of the U-shaped turnbuckle 62 are integrally connected (as by welding) to a threaded member 70 having reversing threads as used in a conventional turnbuckle arrangement. A turnbuckle 62 as just described is attached to each end of each section 16, 18, 20 and 21 (i.e., two turnbuckles 62 per section) and adjacent turnbuckles are interconnected with a threaded shaft 72 that has its opposite ends threaded into adjacent threaded members 70 as shown in FIG. 4. A nut 74 is fixed on threaded shaft 72 near the middle of the shaft, between adjacent turnbuckles 62, so that the shaft may be manipulated—rotated—with a wrench. The threads on shaft 72 on either side of nut 74 are reversed in orientation so that the shaft may be threaded onto the reversed threads of the two turnbuckles 62. By rotation nut 74, the shaft 72 is rotated and the adjacent sections 16 and 18 are either drawn together toward one-another, or driven away from one another, depending on the direction of rotation of the nut 74 (arrows A and B, FIGS. 2 and 6).

It will be appreciated that the diameter of expansion ring 12 is increased or decreased by adjustment of the expansion joints 22 as just described. As the diameter is adjusted, the slip joints 28 maintain the stable connection between adjacent sections 16, 18, 20 and 21.

An expansion ring 12 may include more than four sections and expansion joints 22, or fewer, and may include more or fewer retaining bolts 50 than shown in the drawings.

With returning reference to FIG. 1, the filter used in connection with the expansion ring described above may be of the type described in U.S. Pat. No. 8,221,632, Surface Water Filtration Device, the disclosure of which is incorporated herein in its entirety. Other filter types may also be utilized. The filter includes a suspending plate 80 that is circular and which rests on the shelf 24. A filter basket assembly 82 is suspended on the suspending plate 80 through a central opening 84 in the suspending plate such that the filter basket assembly remains in the manhole 100.

The apparatus 10 may be of any appropriate size for the manhole 100 in which the apparatus is to be installed. While there are standard dimensions for manholes, there is variability in the interior measurements, diameters, etc. Accordingly, the expansion ring 12 may be made in various sizes. An appropriately sized expansion ring is installed in a manhole 100 by inserting the ring 12 with the retention bolts 50 in their retracted positions (i.e., with the bolts loosened such that the pointed distal ends 58 are near the vertical side wall portion 26 and extending past the side wall only minimally if at all). The diameter of the expansion ring 12 should be slightly smaller than the diameter of the manhole when the expansion joints 22 are in their retracted position—that is, when the diameter of the expansion ring is near its minimum.

The expansion ring 12 is inserted into the manhole 100 in a position as shown in FIG. 1 and the expansion joints 22 between sections 16, 18, 20 and 21 are sequentially expanded by rotation of nuts 74 to increase the overall diameter of the expansion ring 12 until the vertical side wall portion 26 approaches or abuts the interior wall of the manhole. The slip joints 28 maintain the orientation of the sections 16, 18, 20 and 21 during the installation and keep the adjacent sections stably connected to one another regardless of the positions of the expansion joints. The retaining bolts 50 are then manipulated with a wrench to extend and drive the pointed distal ends 58 into the side wall of the manhole. Because the distal ends 58 are pointed, as the retaining bolts are driven into the side wall of the manhole the pointed distal ends 58 bear into the side wall of the manhole to provide a secure connection. The bolts 50 are all rotated until the distal ends are firmly seated in the side wall of the manhole. The lock nuts 60 are then tightened to secure the position of the expansion ring 12.

At this point the filter basket assembly 82 may be installed as described above.

When assembled in this manner, fluid from a Vactor truck may be decanted into the manhole by emptying the liquid into and through the filter basket assembly. Filtered water flows through the basket assembly and solids and other components removed from the water are retained in the filter basket assembly (which may be removed, cleaned and replaced as necessary).

In addition to the apparatus described above, the present invention further contemplates a method of collecting storm water from storm drain systems and decanting the collected storm water—the method enabled by the apparatus. Specifically, the method involves the identification of plural clean-out locations to define a clean-out route. The clean-out route is a set route that a Vactor truck or sweeper follows and which has plural clean-out locations on the route. Each clean-out location is an individual manhole or storm drain such as a curb inlet vault that is to be cleaned by the Vactor truck.

Having established the clean-out route, plural apparatuses 10 are installed in the manholes at selected clean-out locations on the route. The manholes in which the apparatus 10 are installed are referred to herein as the “decanting locations.” Typically, the decanting locations are strategically located on the clean-out route so that they are separated from one another by multiple other clean-out locations—that is, multiple storm drains that are being cleaned on the route. The decanting locations are located so that there are enough clean-out locations between each decanting locations so that the Vactor truck is full and ready to be emptied—decanted—at each decanting location. By following this method, the Vactor truck is emptied along the route and the fluid from the truck that normally would be emptied at a distant treatment facility is filtered on-route into the storm drain system. This method eliminates the need to drive the truck to the treatment facility every time it is full, with significant savings in fuel, labor and wear and tear on the equipment.

An alternative embodiment of an expansion ring 200 is illustrated in FIG. 6. Expansion ring 200 functions in the same manner as apparatus 10 described above and installed in a manhole 100 in the same manner. However, the expansion ring comprises only two sections 202 and 204 having first ends attached to one-another with a hinge 206 and opposite ends interconnected with an expansion joint 22 identical to those described above. It will be appreciated that with an expansion ring 200 that has two sections such as shown in FIG. 6, each section 202 and 204 defines an arc of about 180 degrees. On the other hand, with an expansion ring 12 as shown in FIG. 2 that has four sections 16, 18, 20 and 21, each section defines an arc of about 90 degrees.

While the present invention has been described in terms of a preferred embodiment, it will be appreciated by one of ordinary skill that the spirit and scope of the invention is not limited to those embodiments, but extend to the various modifications and equivalents as defined in the appended claims.

1. A expansion ring for a manhole, comprising:
plural curved sections interconnected to define a cylindrical ring member having a diameter;
at least one expansion joint interconnecting two adjacent sections, the at least one expansion joint operable to increase and decrease the diameter;
plural retaining bolts.

2. The expansion ring according to claim 1 including at least four curved sections, each having opposite ends, each opposite end interconnected with an opposite end of an adjacent section with an expansion joint.

3. The expansion ring according to claim 2 with at least one retaining bolt in each section.

4. The expansion ring according to claim 1 wherein each of the plural curved sections has opposite ends and each of the plural curved sections includes an arm extending beyond each of said opposite ends toward the adjacent curved section, wherein said arms from adjacent sections align with one another to thereby stabilize adjacent sections relative to one another.

5. The expansion ring according to claim 4 wherein an arm extending from one section defines a channel for receiving an arm from an adjacent section.

6. The expansion ring according to claim 5 wherein said expansion ring has an outer periphery and said retaining bolts are expandable through said outer periphery.

7. The expansion ring according to claim 6 wherein the retaining bolts have pointed tips.

8. The expansion ring according to claim 7 installed in said manhole such that said expansion ring is supported in said manhole with the pointed tips of said retaining bolts bearing against a wall of said manhole.

9. The expansion ring according to claim 1 wherein the expansion ring has a peripheral edge that defines a peripheral shelf and an open interior.

10. The expansion ring according to claim 9 including a filter basket assembly in the open interior and suspended form said peripheral shelf.

11. The expansion ring according to claim 1 defined by two curved sections, each defining approximately a 180 degree curve and having first ends interconnected with a hinge and second ends interconnected with an expansion joint.

12. An expansion ring for a manhole, comprising:
interconnected arcuate members, each having opposite ends interconnected to opposite ends of adjacent arcuate members with expansion joints to define a cylindrical ring member having diameter and an open interior and a peripheral shelf, wherein said diameter may be varied with said expansion joints.

13. The expansion ring according to claim 12 in which each expansion joint is defined by a turnbuckle.

14. The expansion ring according to claim 13 including plural retaining bolts spaced around said cylindrical ring member and extending through a peripheral edge thereof.

15. The expansion ring according to claim 14 wherein each retaining bolt is extendable to extend a tip of said bolt away from said peripheral edge.

16. An expansion ring for a manhole, comprising:
plural sections interconnected to define a ring having a diameter;
expansion means for increasing and decreasing the diameter; and
retaining means for fixing said extension ring to said manhole.

17. The expansion ring according to claim 16 further comprising stabilizing means for stabilizing adjacent sections relative to one another.

18. The expansion ring according to claim 17 wherein the expansion means are defined by adjustable expansion joints interconnecting adjacent sections.

19. The expansion ring according to claim 18 wherein the retaining means are defined by plural retaining bolts extending through a peripheral wall of said ring, each of said retaining bolts having a pointed end.

20. The expansion ring according to claim 19 wherein said stabilizing means are defined by each of the plural sections having opposite ends with an arm extending beyond each of said opposite ends toward the adjacent curved section, wherein said arms from adjacent sections interact with one another to stabilize adjacent sections relative to one another.
